(19) United States
(12) Patent Application Publication
(10) Pub. No.: US 2026/0056679 A1
(43) Pub. Date: Feb. 26, 2026

(54) STORAGE DEVICE, DISCONNECTION DETECTION METHOD, AND DRIVE BOX

(71) Applicant: Hitachi Vantara, Ltd., Yokohama-shi (JP)

(72) Inventor: Kazuaki NISHIO, Tokyo (JP)

(73) Assignee: Hitachi Vantara, Ltd., Yokohama-shi (JP)

(21) Appl. No.: 19/076,323

(22) Filed: Mar. 11, 2025

(30) Foreign Application Priority Data
Aug. 26, 2024 (JP) 2024-144439

(51) Int. Cl. G06F 3/06; G06F 1/26

(52) U.S. Cl. CPC G06F 3/0658; G06F 1/263; G06F 3/0617; G06F 3/0683

(57) ABSTRACT

To identify the location of a disconnection in a signal line used for communication with various specific elements other than storage drives. A controller accesses each of a plurality of elements in a drive box through a signal line via each of first and second expanders in the drive box having a plurality of storage drives, and if a disconnection occurs in the signal line, determines the location of the disconnection on the basis of an access result pattern indicating whether or not access to each of the plurality of elements via the first and second expanders is possible.

### BACKGROUND

The present invention relates generally to disconnection detection.

A technology for identifying disconnections in electronic devices is, for example, disclosed in Japanese Unexamined Patent Application Publication No. 2005-308556.

### SUMMARY

A storage device generally has a controller and storage drives, and the controller communicates with various specific elements other than the storage drives (for example, memory and microcontroller units within a plurality of units in a storage device) via signal lines (for example, a bus) for data collection and control. The signal lines extend to the plurality of units in the storage device. Signal lines are usually dual-redundant, so that even if there is a disconnection in one signal line, communication can still be carried out via another signal line, but it is desirable to be able to identify where the disconnection occurred in the signal line. For example, if the disconnection location can be identified, it is possible to eliminate the disconnection location by replacing the unit having the disconnection location or by other methods.

With the electronic device described in Japanese Unexamined Patent Application Publication No. 2005-308556, it is possible to identify a disconnection in any of a plurality of harnesses, but it is not possible to identify the disconnection location in the harness. Therefore, even if the electronic device disclosed in Japanese Unexamined Patent Application Publication No. 2005-308556 is applied to a storage device, it is not possible to identify the location of the disconnection.

A controller accesses each of a plurality of elements in a drive box through a signal line via each of first and second expanders in the drive box having a plurality of storage drives, and if a disconnection occurs in the signal line, determines the location of the disconnection on the basis of an access result pattern indicating whether or not access to each of the plurality of elements via the first and second expanders is possible.

According to the present invention, it is possible to identify the location of a disconnection in a signal line used for communication with various specific elements other than storage drives. Problems, configurations, and effects other than those described above will become apparent from the following description of the embodiment.

### BRIEF DESCRIPTION OF THE DRAWINGS

FIG. 1 is a block diagram of a drive box according to a comparative example;

FIG. 2A illustrates a block configuration of a storage device according to an embodiment and locations (0a) to (0q) IN I2C0;

FIG. 2B illustrates a block configuration of the storage device according to the embodiment and locations (1a) to (1q) in I2C1;

FIG. 3A illustrates the configuration of a disconnection diagnosis table for the locations (0a) to (0q) in the I2C0;

FIG. 3B illustrates the configuration of a disconnection diagnosis table for the locations (1a) to (1q) in the I2C1;

FIG. 4A is a flowchart of part of disconnection diagnosis processing;

FIG. 4B is a flowchart of the rest of the disconnection diagnosis processing; and

FIG. 5 is a schematic diagram of the configuration of the storage device according to the embodiment.

### DETAILED DESCRIPTION OF PREFERRED EMBODIMENT

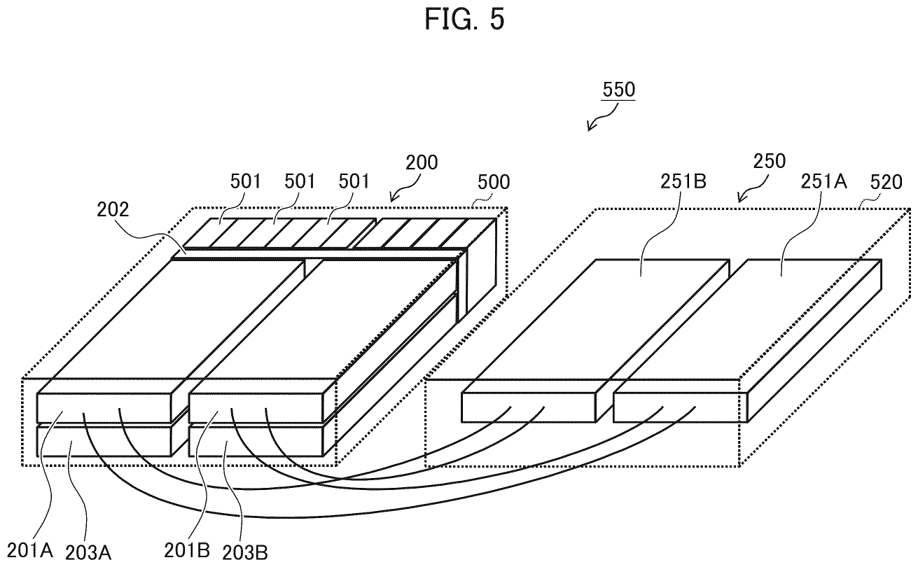

FIG. 5 is a schematic diagram of the configuration of a storage device according to an embodiment.

A storage device 550 has a drive box 200 and a controller box 250.

The drive box 200 has a housing 500. The height of the housing 500 may be 1 U or 2 U. A plurality of units, excluding a controller and a drive 501, are provided within the housing 500. The plurality of units include an interface unit 201, a midplane (circuit board) 202, and a power supply unit 203.

A plurality of the drives 501 are connected to one surface of the midplane 202. The plurality of drives 501 are lined up in the width direction. The drives 501 are storage drives (drives having a storage medium), and are typically HDDs (Hard Disk Drives) or SSDs (Solid State Drives).

To the other surface of the midplane 202, the dual-redundant interface units 201 (201A and 201B) and the dual-redundant power supply units 203 (203A and 203B) are connected.

The controller box 250 has a housing 520. The height of the housing 520 may be 1 U or 2 U. The controller box 250 has dual-redundant controllers 251 (251A and 251B). Each of the controllers 251A and 251B is connected to the interface units 201A and 201B in the drive box 200. Each of the controllers 251A and 251B receives power from the power supply units 203A and/or 203B via (or not via) the interface units 201A and/or 201B.

The various elements (in the example illustrated in FIG. 5, the interface units 201, the power supply units 203, and the controllers 251) in the storage device 550 are dual-redundant, so that even if an abnormality occurs in one of the dual-redundant elements, processing can be continued by the other element.

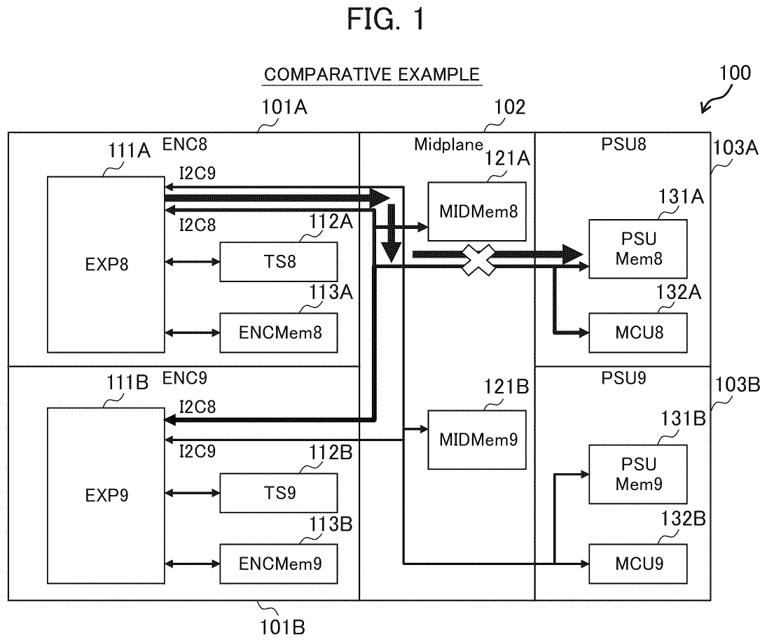

In this embodiment, when a disconnection occurs in the drive box 200, the disconnection location can be identified. Meanwhile, in the comparative example, as illustrated in FIG. 1, the disconnection location in the drive box cannot be identified.

Specifically, in the comparison example, in the drive box 100, the interface units 101A and 101B (ENC8 and ENC9) and the power supply units 103A and 103B (PSU8 and PSU9) are connected to the midplane 102. The ENC8 has an expander 111A (EXP8), a temperature sensor 112A (TS8), and an EEPROM 113A (ENCMem8). The ENC9 has an expander 111B (EXP9), a temperature sensor 112B (TS9), and an EEPROM 113B (ENCMem9). The midplane 102 has EEPROMs 121A and 121B (MIDMem8 and MIDMem9). The PSU8 has an EEPROM 131A (PSUMem8) and a microcontroller unit 132A (MCU8). The PSU9 has an EEPROM 131B (PSUMem9) and a microcontroller unit 132B (MCU9).

The signal lines include I2C8 and I2C9. Each of the I2C8 and the I2C9 is a serial bus, and communication according to I2C (Inter-Integrated Circuit, or I-squared-C) is performed. For example, data (for example, production number) is obtained from one of the EEPROMs or a fan (for example, a fan in the PSU8 or PSU9) is controlled by an MCU132. Each of the I2C8 and the I2C9 spans a plurality of units such as the ENC8, the ENC9, the midplane 102, the PSU8, and the PSU9. The EXP8, the EXP9, the MIDMem8, the PSUMem8 and the MCU8 are connected to the I2C8. The EXP8, the EXP9, the MIDMem9, the PSUMem9, and the MCU9 are connected to the I2C9. That is, either the EXP8 or the EXP9 can access the MIDMem8, the PSUMem8, or the MCU8 via the I2C8 or access the MIDMem9, the PSUMem9 or the MCU9 via the I2C9.

In communication via the I2C8 (or I2C9), it can happen that the PSU8 (or PSU9) cannot be accessed from the controller through the EXP8 (or EXP9). This may be caused by either an I2C8 disconnection (or an I2C9 disconnection) within the PSU8 or an I2C8 disconnection (or an I2C9 disconnection) within the midplane 202. However, even if one of them is the cause, it is not possible to identify which one is the cause (distinguish the disconnection location). For example, as illustrated in FIG. 1, even if the cause is the I2C8 disconnection within the midplane 202, it is not possible to identify that the I2C8 disconnection location is within the midplane 202.

The present embodiment can address the problem of the comparative example. Note that in the following description, “EEPROM”is an example of a memory.

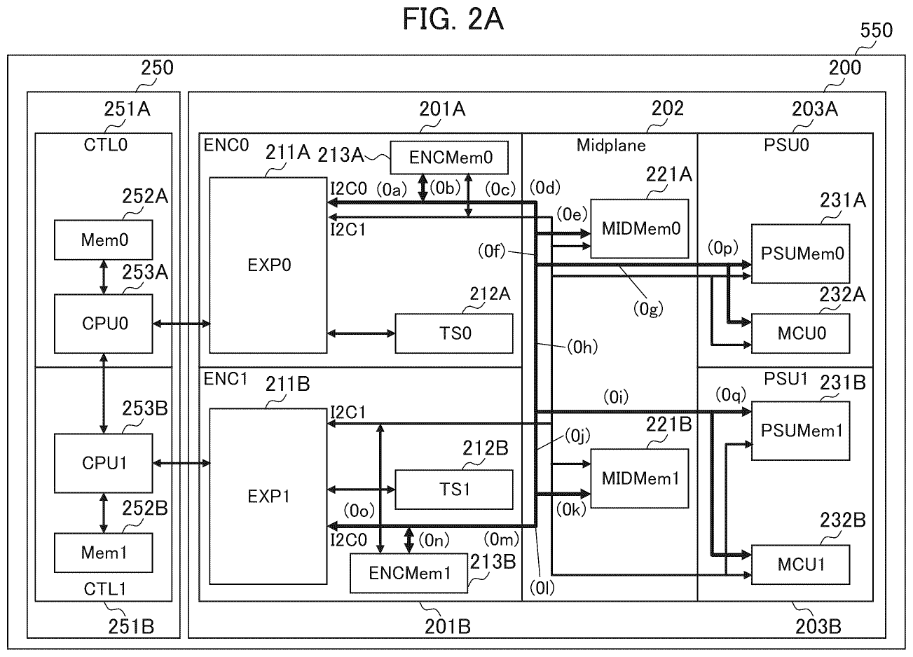

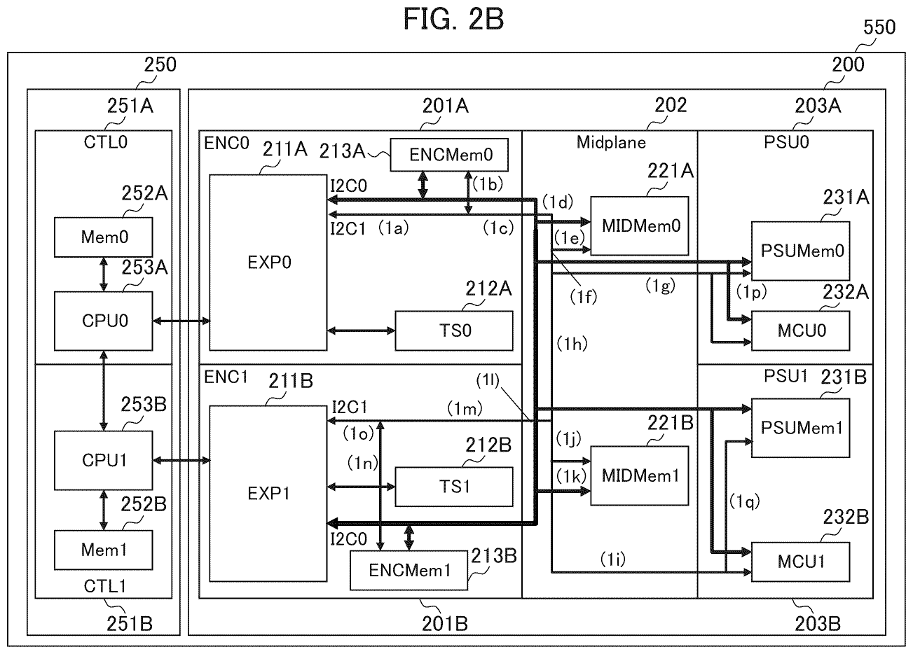

FIGS. 2A and 2B are block diagrams of the storage device 550 according to the embodiment. (0a) to (0q) in FIG. 2A represent locations in I2C0, and (1a) to (1q) in FIG. 2B represent locations in I2C1. Note that in FIGS. 2A and 2B, the drives 501 are not illustrated. This is because a signal line for communication according to I2C is not connected to the drives 501. In other words, the signal line is different from a line (not illustrated) through which the data to be input/output to/from at least one of the plurality of drives 501 passes.

The storage device 550 includes the drive box 200 and the controller box 250, as described above.

The drive box 200 has the interface units 201A and 201B (ENC0 and ENC1), the midplane 202, and the power supply units 203A and 203B (PSU0 and PSU1). The ENC0 has an expander 211A (EXP0), a temperature sensor 212A (TS0), and an EEPROM 213A (ENCMem0). The ENC1 has an expander 211B (EXP1), a temperature sensor 212B (TS1), and an EEPROM 213B (ENCMem1). Each of the EXP0 and the EXP1 can be a switch circuit. The plurality of drives 501 may be connected to each of the EXP0 and the EXP1 via a data line (not illustrated) through which I/O data flows. In response to an I/O request to the CTL0 or the CTL1, data I/O is performed to/from the drives 501 through the data line via the EXP0 or the EXP1 by the CTL0 or the CTL1. The midplane 202 has an EEPROM 221A (MIDMem0) and an EEPROM 221B (MIDMem1). The PSU0 has an EEPROM (PSUMem0) and an MCU 232A (MCU0). The PSU1 has an EEPROM (PSUMem1) and an MCU 232B (MCU1).

The controller box 250 has the controllers 251A and 251B (CTL0 and CTL1). The CTL0 has a memory 252A (Mem0) and a CPU 253A (CPU0) connected to the Mem0. The CTL1 has a memory 252B (Mem1) and a CPU 253B (CPU1) connected to the Mem1. The CPU0 is connected to the EXP0 and the CPU1 is connected to the EXP1. The CTL0 (for example, CPU0) and CTL1 (for example, CPU1) can communicate with each other in the controller box 250.

The I2C0 and the I2C1 extend to the plurality of units in the drive box 200 as dual-redundant signal lines. The EXP0, the ENCMem0, the MIDMem0, the PSUMem0, the MCU0, the EXP1, the ENCMem1, the MIDMem1, the PSUMem1, and the MCU1 are connected to each of the I2C0 and the I2C1. By executing the program stored in the Mem0, the CPU0 can access a desired specific element among the plurality of specific elements such as the ENCMem0, the MIDMem0, the PSUMem0, the MCU0, the ENCMem1, the MIDMem1, the PSUMem1, and the MCU1 through the I2C0 or I2C1 via the EXP0, and can perform disconnection diagnostic processing described below. By executing the program stored in the Mem1, the CPU1 can access a desired specific element among the plurality of specific elements such as the ENCMem0, the MIDMem0, the PSUMem0, the MCU0, the ENCMem1, the MIDMem1, the PSUMem1, and the MCU1 through the I2C0 or I2C1 via the EXP1, and can perform disconnection diagnostic processing described below.

For example, the CPU0 (or CPU1) receives, via the EXP0 (or EXP1), data representing the temperature detected by the TS0 (or TS1) and transmits a control command for controlling a fan (not illustrated) in the PSU0 (or PSU1) according to the temperature represented by the data to the MCU0 (or MCU1) through the I2C0 (or I2C1) via the EXP0 (or EXP1).

In this embodiment, a plurality of locations are specified for each of the I2C0 and the I2C1. Specifically, for the I2C0, the locations (0a) to (0q) are specified as illustrated in FIG. 2A, and for the I2C1, the locations (1a) to (1q) are defined as illustrated in FIG. 2B.

From another perspective, if a disconnection occurs in each of the I2C0 and the I2C1, in order to make it possible to identify the disconnection location, each of the I2C0 and the I2C1 is connected to the EXP0 or the EXP1, each memory (each of the MIDMem0 and the MIDMem1) in the midplane 202, and each memory (each of the ENCMem0, the ENCMem1, the PSUMem0, and the PSUMem1) in the ENC0, ENC1, PSU0, and PSU1 connected to the midplane 202. Each of the CTL0 and the CTL1 accesses each memory in the ENC0, the ENC1, the midplane 202, the PSU0, and the PSU1 through each of the I2C0 and the I2C1 via the EXP0 or the EXP1, and determines, from the access result pattern, which is a combination of access results (access possible/not possible) for each memory, whether a disconnection has occurred in either the I2C0 or the I2C1 or both, and if so, at which location in the I2C0 and/or the I2C1. The disconnection location that can be identified in this determination are one of (0a) to (0q) or one of (1a) to (1q), based on the connection configuration of each of the I2C0 and the I2C1. (0a) to (0q) and (1a) to (1q) are as follows.
(0a) is within the ENC0, and between the EXP0 and the branch to the ENCMem0.
(0b) is within the ENC0, and between the branch to the ENCMem0 and the ENCMem0.
(0c) is within the ENC0, and between the branch to the ENCMem0 and the boundary between the ENC0 and the midplane 202.
(0d) is within the midplane 202, and between the boundary between the ENC0 and the midplane and the branch to the MIDMem0.
(0e) is within the midplane 202, and between the branch to the MIDMem0 and the MIDMem0.
(0f) is within the midplane 202, and between the branch to the MIDMem0 and the branch to the PSU0.
(0g) is within the midplane 202, and between the branch to the PSU0 and the boundary between the midplane 202 and the PSU0.
(0h) is within the midplane 202, and between the branch to the PSU0 and the branch to the PSU1.
(0i) is within the midplane 202, and between the branch to the PSU1 and the boundary between the midplane 202 and the PSU1.
(0j) is within the midplane 202, and between the branch to the PSU1 and the branch to the MIDMem1.
(0k) is within the midplane 202, and between the branch to the MIDMem1 and the MIDMem1.
(0l) is within the midplane 202, and between the branch to the MIDMem1 and the boundary between the ENC1 and the midplane 202.
(0m) is within the ENC1, and between the branch to the ENCMem1 and the boundary between the ENC1 and the midplane 202.
(0n) is within the ENC1, and between the branch to the ENCMem1 and the ENCMem1.
(0o) is within the ENC1 and between the EXP1 and the branch to the ENCMem1.
(0p) is within the PSU0, and between the boundary between the midplane 202 and the PSU0 and the PSUMem0.
(0q) is within the PSU1, and between the boundary between the midplane 202 and the PSU1 and the PSUMem1.
(1a) is within the ENC0, and between the EXP0 and the branch to the ENCMem0.
(1b) is within the ENC0, and between the branch to the ENCMem0 and the ENCMem0.
(1c) is within the ENC0, and between the branch to the ENCMem0 and the boundary between the ENC0 and the midplane 202.
(1d) is within the midplane 202, and between the boundary between the ENC0 and the midplane and the branch to the MIDMem0.
(1e) is within the midplane 202, and between the branch to the MIDMem0 and the MIDMem0.
(1f) is within the midplane 202, and between the branch to the MIDMem0 and the branch to the PSU0.
(1g) is within the midplane 202, and between the branch to the PSU0 to the boundary between the midplane 202 and the PSU0.
(1h) is within the midplane 202, and between the branch to the PSU0 and the branch to the ENC1.
(1i) is within the midplane 202, and between the branch to the MIDMem1 and the boundary between the midplane 202 and the PSU1.
(1j) is within the midplane 202, and between the branch to the ENC1 and the branch to the MIDMem1.
(1k) is within the midplane 202, and between the branch to the MIDMem1 and the MIDMem1.
(1l) is within the midplane 202, and between the branch to the ENC1 and the boundary between the ENC1 and the midplane 202.
(1m) is within the ENC1, and between the branch to the ENCMem1 and the boundary between the ENC1 and the midplane 202.
(1n) is within the ENC1, and between the branch to the ENCMem1 and the ENCMem1.
(1o) is within the ENC1, and between the EXP1 and the branch to the ENCMem1.
(1p) is within the PSU0, and between the boundary between the midplane 202 and the PSU0 and the PSUMem0.
(1q) is within the PSU1, and between the boundary between the midplane 202 and the PSU1 and the PSUMem1.

For each of the I2C0 and the I2C1, another location may be specified in place of or in addition to at least one of the above locations. For example, a location within the PSU0 and between the boundary between the midplane 202 and the PSU0 and the MCU0 may be newly specified for the I2C0, and similarly, a location within the PSU1 and between the boundary between the midplane 202 and the PSU1 and MCU1 may be newly specified for the I2C1. In this manner, for each of the I2C0 and the I2C1, the location may be specified according to the element to which the signal line is connected.

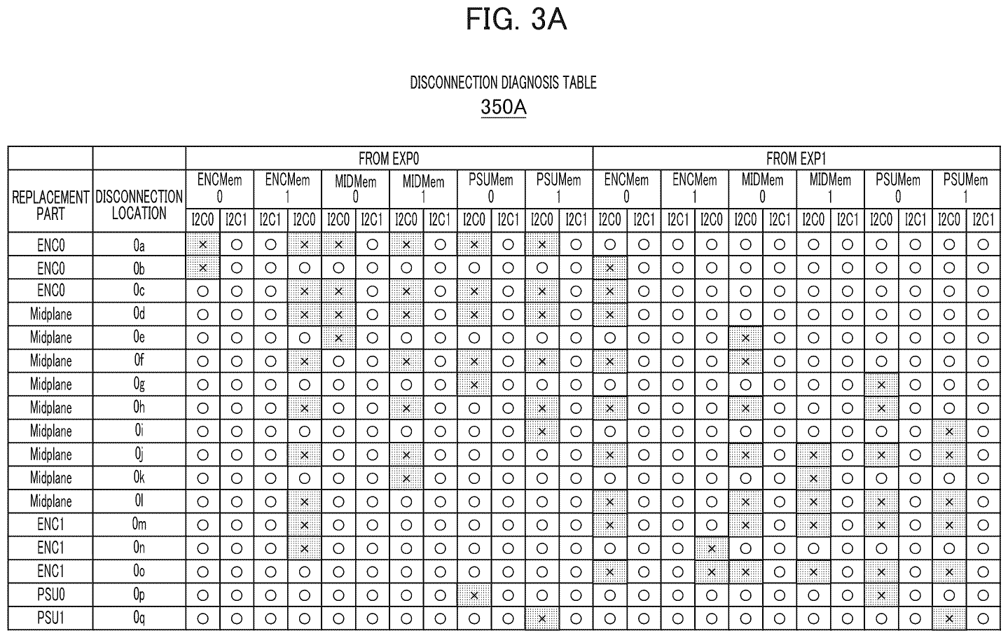

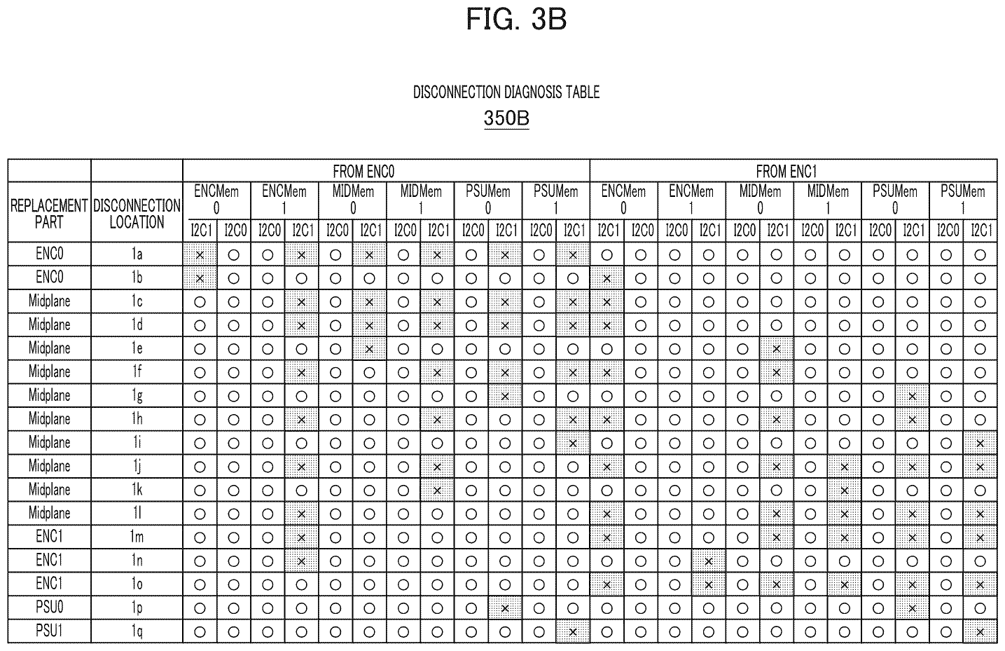

In order to determine where the disconnection has occurred, the Mem0 and the Mem1 store disconnection diagnosis tables 350A and 350B illustrated in FIGS. 3A and 3B, respectively.

The disconnection diagnosis table 350A represents, for each of the locations (0a) to (0q) in the I2C0, the access result pattern when the location is a disconnection location. The disconnection diagnosis table 350B represents, for each of the locations (1a) to (1q) in the I2C1, the access result pattern when the location is a disconnection location. In both disconnection diagnostic tables 350A and 350B, column “FROM EXP0” represents the result of accessing each of the ENCMem0, the ENCMem1, the MIDMem0, the MIDMem1, the PSUMem0, and the PSUMem1 through each of the I2C0 and the I2C1 via the EXP0. Column “FROM EXP1” represents the result of accessing each of the ENCMem0, the ENCMem1, the MIDMem0, the MIDMem1, the PSUMem0, and the PSUMem1 through each of the I2C0 and the I2C1 via the EXP1. For example, according to the access result pattern when (0q) is the disconnection location, access from the CPU0 to the PSUMem1 via the EXP0 and the I2C0 and from the CPU1 to the PSUMem1 via the EXP1 and the I2C0 are not possible, while other accesses are possible. Similarly, for example, according to the access result pattern when (1q) is the disconnection location, access from the CPU0 to the PSUMem1 via the EXP0 and the I2C1 and from the CPU1 to the PSUMem1 via the EXP1 and the I2C1 are not possible, while other accesses are possible.

Note that according to each of the disconnection diagnosis tables 350A and 350B, replacement parts include the ENC0, the ENC1, the midplane 202, the PSU0, and the PSU1. That is, each of the ENC0, the ENC1, the midplane 202, the PSU0, and the PSU1 is a replaceable unit. It is possible to recover from a disconnection by replacing the unit having the disconnection location.

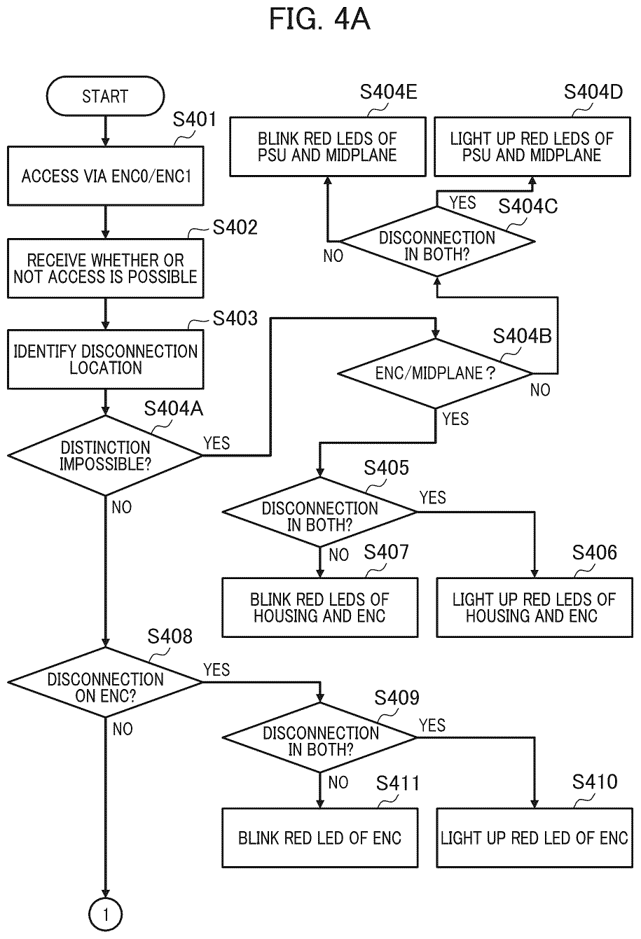

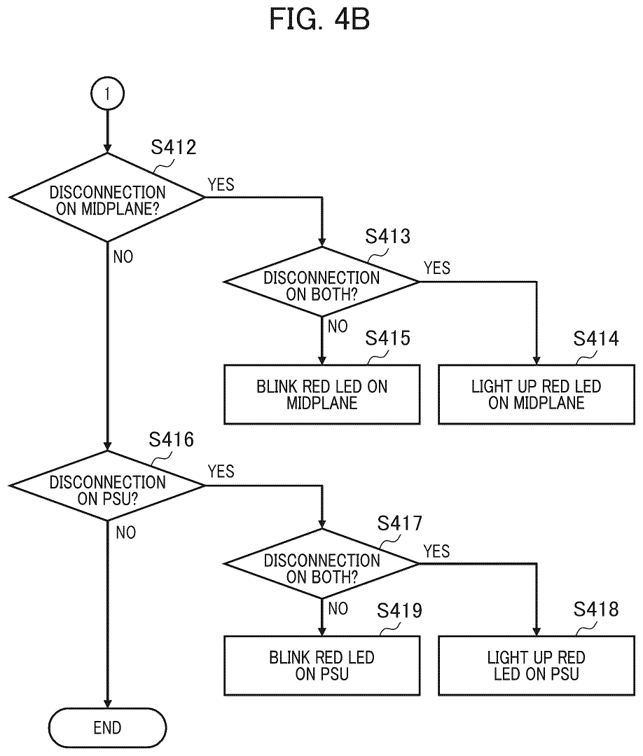

FIGS. 4A and 4B are flowcharts of disconnection diagnosis processing. The disconnection diagnostic processing may be performed when the PSU0 or the PSU1 is powered on, when controlling the fan in the PSU0 or the PSU1, or periodically.

The CPU0 (CPU1) accesses each of the ENCMem0, the ENCMem1, the MIDMem0, the MIDMem1, the PSUMem0, and the PSUMem1 through each of the I2C0 and the I2C1 via the EXP0 (EXP1) (S401), receives the access result (access possible or not) for each access destination, and records the access result in the Mem0 (Mem1) (S402). Thus, data representing the access result via the EXP0 is recorded in the Mem0, and data representing the access result via the EXP1 is recorded in the Mem1.

The CPU0 and the CPU1 share the access result via the EXP0 and the access result via the EXP1, and the CPU0 (and/or the CPU1) determines, from the disconnection diagnosis tables 350A and 350B in the Mem0 (Mem1), the access result pattern matching the access result via the EXP0 and the access result via the EXP1 (S403).

If there is no matching access result pattern, that is, if all access results indicate that access is possible, there is no disconnection, so that the processing ends (S404A: No, S408: No, S412: No, S416: No).

There may be cases where there are a plurality of matching access result patterns and the plurality of access result patterns are disconnection locations in a plurality of different units (S404A: Yes), that is, where the disconnection location cannot be uniquely identified and distinguished. Specifically, for example, there are the following.

The access result patterns of the location (0c) and the location (0d) are the same (see FIG. 3A). That is, the locations (0c) and (0d) span the ENC0 and the midplane 202, and therefore, if the location (0c) or the location (0d) is the disconnection location, it is not possible to distinguish whether the disconnection location is in the ENC0 or in the midplane 202. The same applies to the location (1c) and the location (1d). That is, the access result patterns of the location (1c) and the location (1d) are the same (see FIG. 3B).

The access result patterns of the location (0m) and the location (0l) are the same (see FIG. 3A). That is, the locations (0m) and (0l) span the ENC1 and the midplane 202, and therefore, if the location (0m) or the location (0l) is the disconnection location, it is not possible to distinguish whether the disconnection location is in the ENC1 or in the midplane 202. The same applies to the location (1m) and the location (1l). That is, the access result patterns of the location (1m) and the location (1l) are the same (see FIG. 3B).

The access result patterns of the location (0g) and the location (0p) are the same (see FIG. 3A). That is, the locations (0g) and (0p) span the midplane 202 and the PSU0, and therefore, if the location (0g) or the location (0p) is the disconnection location, it is not possible to distinguish whether the disconnection location is in the midplane 202 or in the PSU0. The same applies to the location (1g) and the location (1p). That is, the access result patterns of the location (1g) and the location (1p) are the same (see FIG. 3B).

The access result patterns of the location (0i) and the location (0q) are the same (see FIG. 3A). That is, the locations (0i) and (0q) span the midplane 202 and the PSU1, and therefore, if the location (0i) or the location (0q) is the disconnection location, it is not possible to distinguish whether the disconnection location is in the midplane 202 or in the PSU1. The same applies to the location (1i) and the location (1q). That is, the access result patterns of the location (1i) and the location (1q) are the same (see FIG. 3B).

If it is impossible to uniquely identify and distinguish the disconnection location (S404A: Yes), the CPU0 (and/or the CPU1) determines whether it is the ENC and the midplane 202 that are indistinguishable, specifically, whether the disconnection location (access pattern) identified in S403 and corresponding to S404A: Yes is in a location related to the ENC or the midplane 202 (S404B).

If the determination result in S404B is true (S404B: Yes), the CPU0 (and/or the CPU1) determines whether or not the disconnection location is in both I2C0 and I2C1 (S405). If the determination result in S405 is true (S405: Yes), the CPU0 (and/or the CPU1) turns on the red LED (Light Emitting Diode) of each of the housing 500 and the ENC0 (and/or the ENC1) (S406). Meanwhile, if the determination result in S405 is false (S405: No), one of the signal lines has no disconnection and can continue to be used, so the CPU0 (and/or the CPU1) blinks the red LED of each of the housing 500 and the ENC0 (and/or the ENC1) as an example of a weaker warning than the case of S405: Yes (S407). The red LED lighting or blinking on both the housing 500 and the ENC is an example of a notification that the disconnection location cannot be distinguished (uniquely identified), or in other words, an example of a way to indicate that both units (for example, both ENC0 or ENC1 and the midplane) should be replaced because the disconnection location cannot be distinguished. The blinking is also an example of a way to report a unit to be preferably replaced as a precaution to prevent both I2C0 and I2C1 from becoming disconnected.

If the determination result in S404B is false (S404B: No), the CPU0 (and/or the CPU1) determines whether or not the disconnection location is in both I2C0 and I2C1 (S404C). If the determination result in S404C is true (S404C: Yes), the CPU0 (and/or the CPU1) turns on the red LED of each of the midplane 202 and the PSU0 (and/or the PSU1) (S404D). Meanwhile, if the determination result in S404C is false (S404C: No), one of the signal lines has no disconnection and can continue to be used, so the CPU0 (and/or the CPU1) blinks the red LED of each of the midplane 202 and the PSU0 (and/or the PSU1) (S404E).

If the disconnection location corresponding to the matching access result pattern is the ENC0 (and/or the ENC1) (S408: Yes), the CPU0 (and/or the CPU1) determines whether or not the disconnection location is in both I2C0 and I2C1 (S409). If the determination result in S409 is true (S409: Yes), the CPU0 (and/or the CPU1) turns on the red LED of the ENC0 (and/or the ENC1) having the disconnection location, that is, the replacement part (S410). If the determination result in S409 is false (S409: No), the CPU0 (and/or the CPU1) blinks the red LED of the ENC0 (and/or the ENC1) having the disconnection location (S411).

If the disconnection location corresponding to the matching access result pattern is the midplane 202 (S412: Yes), the CPU0 (and/or the CPU1) determines whether or not the disconnection location is in both I2C0 and I2C1 (S413). If the determination result in S413 is true (S413: Yes), the CPU0 (and/or the CPU1) turns on the red LED of the midplane 202 having the disconnection location (S414). If the determination result in S413 is false (S413: No), the CPU0 (and/or the CPU1) blinks the red LED of the midplane 202 having the disconnection location (S415).

If the disconnection location corresponding to the matching access result pattern is the PSU0 (and/or the PSU1) (S416: Yes), the CPU0 (and/or the CPU1) determines whether or not the disconnection location is in both I2C0 and I2C1 (S417). If the determination result in S417 is true (S417: Yes), the CPU0 (and/or the CPU1) turns on the red LED of the PSU0 (and/or the PSU1) having the disconnection location (S418). If the determination result in S417 is false (S417: No), the CPU0 (and/or the CPU1) blinks the red LED of the PSU0 (and/or the PSU1) having the disconnection location (S419).

According to this embodiment, the CPU0 and the CPU1 access (for example, send disconnection diagnosis signals or dummy signals) the ENCMem0, the ENCMem1, the MIDMem0, the MIDMem1, the PSUMem0, and the PSUMem1 (examples of the plurality of elements) through the I2C0 and the I2C1 via the EXP0 and the EXP1, respectively and, if at least one of the I2C0 and the I2C1 has a disconnection, determine which of the plurality of prespecified locations has the disconnection, on the basis of the access result pattern indicating whether or not each access is possible. Specifically, in the present embodiment, the CTL0 (and/or the CTL1) stores the disconnection diagnosis tables 350A and 350B (examples of disconnection diagnosis data) that represent, for each of the plurality of prespecified locations on the I2C0 or the I2C1, the access result patterns when the location is a disconnection location. If the disconnection diagnosis table 350A or 350B has an access result pattern that matches the access result pattern indicating whether or not access to each of the ENCMem0, the ENCMem1, the MIDMem0, the MIDMem1, the PSUMem0, and the PSUMem1 via the EXP0 and the EXP1 is possible, the CTL0 (and/or the CTL1) determines the location corresponding to the matching access result pattern as the disconnection location. In this manner, it is possible to identify the location of a disconnection in the signal line used for communication with various specific elements other than the drives 501. This allows the disconnection location to be distinguished without spanning the plurality of units, thereby enabling the replacement of only the unit having the disconnection location. Note that the signal lines do not necessarily have to be dual-redundant like the I2C0 and the I2C1. Also note that in place of or in addition to the I2C0 and the I2C1, the signal lines may be signal lines through which communication is performed according to standards other than the I2C.

According to the present embodiment, the CTL0 (and/or the CTL1) may report the unit having the determined disconnection location, for example, by lighting or blinking the LED of the unit, or by displaying information representing the unit on a display device (e.g., information processing terminal). Thus, it is possible to identify which of the plurality of units should be replaced to restore the I2C0 or the I2C1. In addition, the manner in which the unit having a disconnection location is reported (for example, LED lighting and LED blinking) differs depending on whether there is a disconnection location in either the I2C0 or the I2C1 or both. This allows a user to decide when to replace the unit, depending on the manner of notification.

In addition, according to the present embodiment, in the disconnection diagnosis tables 350A and 350B (an example of disconnection diagnosis data), for each of one or more location sets of the plurality of locations, two locations (an example of two or more locations) belonging to the location set have the same access result pattern and the location set spans the midplane 202 and the ENC0 or ENC1, or spans the midplane 202 and the PSU0 or PSU1. If the access result pattern that matches the access result in S403 (access result via the EXP0 and access result via the EXP1) is an access result pattern for the locations belonging to one of the location sets, the CTL0 (and/or the CTL1) reports the two units that the location set spans (for example, LED lights or blinks for each of the two units). The method for reporting the unit may be any method, for example, in place of or in addition to the lighting or blinking of the LED of the unit, information representing the two units that the location set spans may be displayed on the display of a computer (such as a personal computer) that can communicate with the storage device. In this manner, according to this embodiment, it is possible to identify that the disconnection location cannot be distinguished, and to provide an output according to the determination result that the disconnection location cannot be distinguished, for example, to maintenance personnel, so that appropriate replacement can be performed quickly.

Note that in the present embodiment, the plurality of location sets include a first location set that spans the midplane 202 and the ENC0 or ENC1 and a second location set that spans the midplane 202 and the PSU0 or PSU1. If the above matching access result pattern is an access result pattern for the locations belonging to one of the location sets (for example, S404A: Yes), the CTL0 (and/or the CTL1) determines whether the location set is the first location set or the second location set (for example, S404B) and reports the two units that the determined location set spans.

As described above, the present invention is not limited to the above-described embodiment, and includes various modifications and equivalent configurations within the spirit of the appended claims. The above-described embodiment has been described in detail in order to facilitate the understanding of the present invention, and the present invention is not necessarily limited to an embodiment including all of the described configurations.

For example, in place of or in addition to the red LEDs of the housing 500, the ENC0, the ENC1, the midplane 202, the PSU0, and the PSU1, LEDs of other colors may be mounted and lighted or blinked, and instead of and/or in addition to the LED lighting and/or blinking, the CPU0 (and/or CPU1) may display information representing the disconnection location on an information processing terminal (for example, a personal computer), not illustrated, connected to the storage device 550.

For example, in place of the CPU0 and the CPU1, a CPU in which the CPU0 and the CPU1 are integrated can also be used. Specifically, the controllers do not necessarily have to be dual-redundant, such as the CTL0 and the CTL1, and a single controller 251 may be employed in place of the CTL0 and the CTL1. That is, the controller box 250 may be provided with the single controller 251. The EXP0 and the EXP1 are connected to the controller 251, and the controller 251 may access each of the ENCMem0, the ENCMem1, the MIDMem0, the MIDMem1, the PSUMem0, and the PSUMem1 through each of the I2C0 and the I2C1 via each of the EXP0 and the EXP1. Furthermore, the controller box 250 may be eliminated, in which case the controller 251 (CTL0 and CTL1) may be housed in the housing 500 of the drive box 200 and the drive box 200 may be provided as the storage device 550. Also, the controller, which is an example of a computer, may be a remote computer.

What is claimed is:

1. A storage device comprising
a controller and a drive box,
the drive box including a plurality of storage drives, a plurality of units, and a signal line,
the plurality of units including
a midplane that is a circuit board and to which the plurality of storage drives are connected,
first and second interface units that are dual-redundant interface units connected to the midplane, and
first and second power supply units that are dual-redundant power supply units connected to the midplane,
the first interface unit having a first expander connected to the controller,
the second interface unit having a second expander connected to the controller,
the signal line being different from a line through which data to be input/output to/from at least one of the plurality of storage drives passes,
the signal line having one end connected to the first expander and the other end connected to the second expander,
the signal line being connected to a plurality of elements in the first and second interface units, in the midplane, and in the first and second units,
the controller
accessing each of the plurality of elements through the signal line via each of the first and second expanders, and
if a disconnection occurs in the signal line, determining a location of the disconnection on a basis of an access result pattern indicating whether or not access to each of the plurality of elements via the first and second expanders is possible.

2. The storage device according to claim 1, wherein
the controller stores disconnection diagnosis data,
the disconnection diagnosis data represents, for each of a plurality of prespecified locations on the signal line, the access result pattern when the location is a disconnection location, and
if the disconnection diagnosis data has an access result pattern that matches the access result pattern indicating whether or not access to each of the plurality of elements via the first and second expanders is possible, the controller determines the location corresponding to the matching access result pattern as the disconnection location.

3. The storage device according to claim 1, wherein
the controller reports a unit having the determined disconnection location among the plurality of units.

4. The storage device according to claim 1, wherein
the signal line comprises first and second signal lines that are dual-redundant signal lines,
the controller
accesses each of the plurality of elements through each of the first and second signal lines via each of the first and second expanders, and
if a disconnection occurs in the first and second signal lines, determines the location of the disconnection on the basis of a combination of whether or not access to each of the plurality of elements via the first and second expanders is possible for the first signal line and whether or not access to each of the plurality of elements via the first and second expanders is possible for the second signal line.

5. The storage device according to claim 4, wherein
depending on whether the disconnection location is in both or one of the first and second signal lines in a unit having the determined disconnection location, the controller changes a manner in which the unit having the disconnection location is reported.

6. The storage device according to claim 1, wherein
in the disconnection diagnosis data, for each of one or more location sets of the plurality of locations,
two or more locations belonging to the location set have the same access result pattern, and
the location set spans the midplane and the first or second interface unit, or spans the midplane and the first or second power supply unit, and
if the matching access result pattern is an access result pattern for the locations belonging to one of the location sets, the controller reports two units that the location set spans.

7. The storage device according to claim 6, wherein
in the disconnection diagnosis data, the plurality of location sets includes a first location set that spans the midplane and the first or second interface unit and a second location set that spans the midplane and the first or second power supply unit, and
if the matching access result pattern is an access result pattern for the locations belonging to one of the location sets, the controller determines whether the location set is the first location set or the second location set, and reports two units that the determined location set spans.

8. A disconnection diagnosis method implemented by a computer, the method comprising:
accessing each of a plurality of elements in a drive box through a signal line via each of first and second expanders in the drive box having a plurality of storage drives; and
if a disconnection occurs in the signal line, determining a location of the disconnection on a basis of an access result pattern indicating whether or not access to each of the plurality of elements via the first and second expanders is possible,
the drive box including a plurality of units in addition to the signal line and the plurality of storage drives,
the plurality of units including
a midplane that is a circuit board and to which the plurality of storage drives are connected,
first and second interface units that are dual-redundant interface units connected to the midplane, and
first and second power supply units that are dual-redundant power supply units connected to the midplane,
the first interface unit having a first expander connected to the computer,
the second interface unit having a second expander connected to the computer,
the signal line being different from a line through which data to be input/output to/from at least one of the plurality of storage drives passes,
the signal line having one end connected to the first expander and the other end connected to the second expander,
the signal line being connected to the plurality of elements in the first and second interface units, in the midplane, and in the first and second units.

9. A drive box comprising:
a plurality of storage drives;
a plurality of units; and
a signal line,
the plurality of units including
a midplane that is a circuit board and to which the plurality of storage drives are connected,
first and second interface units that are dual-redundant interface units connected to the midplane, and
first and second power supply units that are dual-redundant power supply units connected to the midplane,
the first interface unit having a first expander,
the second interface unit having a second expander,
the signal line being different from a line through which data to be input/output to/from at least one of the plurality of storage drives passes,
the signal line having one end connected to the first expander and the other end connected to the second expander,
the signal line being connected to a plurality of elements in the first and second interface units, in the midplane, and in the first and second units.
